(19) United States
(12) Patent Application Publication
(10) Pub. No.: US 2025/0045866 A1
(43) Pub. Date: Feb. 6, 2025

(54) Quad-Bayer Demosaicing Using a Machine-Learning Model

(71) Applicant: Meta Platforms Technologies, LLC, Menlo Park, CA (US)

(72) Inventors: Yuchen Fan, San Jose, CA (US); Bo Zhu, Palo Alto, CA (US); Rakesh Ranjan, Mountain View, CA (US); Touraj Tajbakhsh, Carson City, NV (US)

(21) Appl. No.: 18/365,540

(22) Filed: Aug. 4, 2023

(51) Int. Cl. G06T 3/40

(52) U.S. Cl. CPC G06T 3/4015; G06T 3/4007; G06T 3/4046

(57) ABSTRACT

In one embodiment, a method by a computing system associated with an image sensor including a quad-Bayer color filter array includes accessing image-sensor data generated by the image sensor, where the quad-Bayer color filter array comprises sixteen sets of filters, each corresponding to a pixel location within a quad-Bayer pattern, splitting the image-sensor data into sixteen packed channels, where each of the sixteen packed channels corresponds to one of the sixteen sets of filters, producing three channels of interpolated pixels by processing the sixteen packed channels using a machine-learning model, where the three channels comprise red, green, and blue channels, and constructing an output image using the three channels of the interpolated pixels.

### TECHNICAL FIELD

This disclosure generally relates to digital image processing, and in particular, related to demosaicing for quad-Bayer filter arrays.

### BACKGROUND

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to systems and methods for demosaicing quad-Bayer-filtered image-sensor data using a machine-learning model. A Bayer filter array may be suitable to be used in bright conditions to capture sharp and high-resolution images. A quad-Bayer filter array may be suitable to be used in an environment of low illuminance. With a quad-Bayer filer array, adjacent four pixels may be clustered to create per-unit image signal that is four times greater than that of a single pixel. By adding of adjacent pixels in analog, loss of resolution may be prevented, enabling to reduce noise in the resulting image. An ideal computing system may utilize image sensors with Bayer filter array to capture images or videos in an environment of high illuminance and utilize image sensors with quad-Bayer filter array to capture images or videos in an environment of low illuminance. However, certain computing systems, such as an HMD, may not have enough space and/or computing power to be equipped with both Bayer filter array and quad-Bayer filter array. A computing system may have one or more image sensors with quad-Bayer filter arrays. The computing system may perform the demosaicing in a manner that achieves sharp and high-resolution images when the image is taken in an environment of high illuminance. In some legacy systems, the image sensor, in high-illuminance environments, may revert the pixels to the Bayer structure by performing a remosaicing to achieve the high resolution of the Bayer sensor array. The computing system disclosed herein may utilize a machine-learning model to achieve images with minimal noise and maximal resolution either in low-illuminance environments or in high-illuminance environment.

In particular embodiments, a computing system associated with an image sensor comprising a quad-Bayer color filter array may access image-sensor data generated by the image sensor. The quad-Bayer color filter array may comprise sixteen sets of filters. Each set of filters may correspond to a pixel location within a quad-Bayer pattern. The computing system may be associated with an artificial-reality (AR) display. The computing system may split the image-sensor data into sixteen packed channels. Each of the sixteen packed channels may correspond to one of the sixteen sets of filters. The computing system may produce three channels of interpolated pixels by processing the sixteen packed channels using a machine-learning model. The three channels may comprise red, green, and blue channels. In particular embodiments, the machine-learning model may comprise a series of neural networks (NNs). In particular embodiments, the machine-learning model may comprise a series of convolutional neural networks (CNNs). The computing system may construct an output image using the three channels of the interpolated pixels.

In particular embodiments, the machine-learning model may be trained with training images selected from a corpus of images. The corpus of images may comprise randomly cropped images. Each image in the corpus of images may be associated with a score determined based on characteristics of the image. The characteristics may comprise spectral signal frequencies associated with the image. A first image with a first score may have a higher probability of being selected for the training than a second training image with a second score that is lower than the first score. In particular embodiments, the training images may be pre-processed by amplifying red and blue pixels. In particular embodiments, an iteration of training the machine-learning model with a training image may comprise a number of steps. At a first step, image-sensor data may be recovered from the training image. At a second step, the recovered image-sensor data may be split into sixteen packed channels. At a third step, three channels of interpolated pixels may be produced by processing the sixteen packed channels using the machine-learning model. At a fourth step, parameters of the machine-learning model may be updated based on a comparison between the training image and a constructed image using the produced three channels of the interpolated pixels.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 2 illustrates an example logical architecture of an HMD.

FIG. 3 illustrates an example image sensor associated with a color filter array.

FIG. 4 illustrates a comparison between a Bayer filter array pattern and a quad-Bayer filter array pattern.

FIG. 5 illustrates an example process of demosaicing quad-Bayer-filtered image sensor data using a machine-learning model.

FIG. 6 illustrates an example split of a quad-Bayer-filtered image-sensor data into sixteen packed channels.

FIG. 7 illustrates an example method for demosaicing quad-Bayer-filtered image-sensor data using a machine-learning model.

FIG. 8 illustrates an example computer system.

### DESCRIPTION OF EXAMPLE EMBODIMENTS

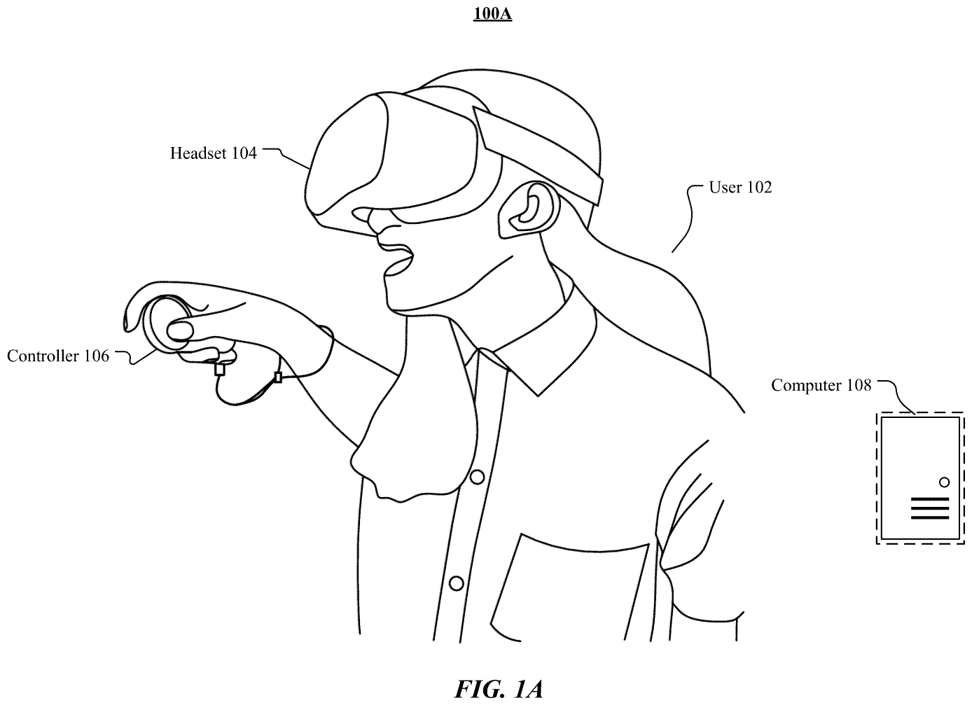

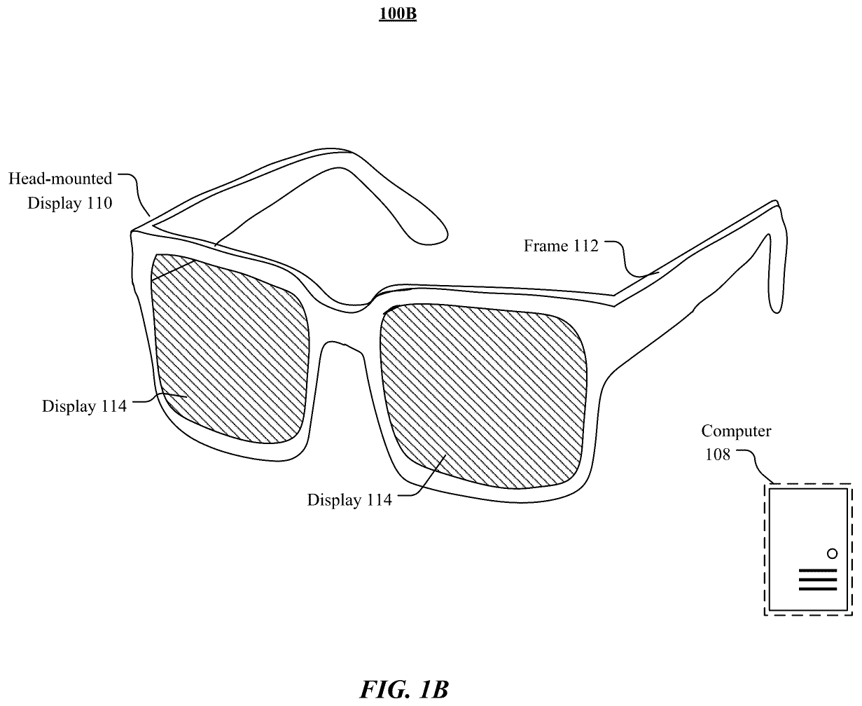

FIG. 1A illustrates an example artificial reality system 100A. Artificial reality is a form of reality that has been adjusted in some manner before presentation to a user 102, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. In particular embodiments, the artificial reality system 100A may comprise a headset 104, a controller 106, and a computing device 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may include a microphone to capture voice input from the user 102. The headset 104 may be referred as a head-mounted display (HMD). The controller 106 may comprise a trackpad and one or more buttons. The controller 106 may receive inputs from the user 102 and relay the inputs to the computing device 108. The controller 106 may also provide haptic feedback to the user 102. The computing device 108 may be connected to the headset 104 and the controller 106 through cables or wireless connections. The computing device 108 may control the headset 104 and the controller 106 to provide the artificial reality content to and receive inputs from the user 102. The computing device 108 may be a standalone host computing device, an on-board computing device integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing device 108. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The HMD 110 may include a microphone to capture voice input from the user. The augmented reality system 100B may further include a controller comprising a trackpad and one or more buttons. The controller may receive inputs from users and relay the inputs to the computing device 108. The controller may also provide haptic feedback to users. The computing device 108 may be connected to the HMD 110 and the controller through cables or wireless connections. The computing device 108 may control the HMD 110 and the controller to provide the augmented reality content to and receive inputs from users. The computing device 108 may be a standalone host computer device, an on-board computer device integrated with the HMD 110, a mobile device, or any other hardware platform capable of providing artificial reality content to and receiving inputs from users.

In particular embodiments, an artificial reality system may have an HMD 104 or 110 with limited computing power and a separate host computing device 108. The HMD 104 or 110 in an artificial reality system may be a computing system. The HMD 104 or 110 may have external-facing cameras that capture the environment of the user. The image sensor along with a color filter array may be configured to only capture light of particular wavelengths at each pixel. For example, a red filter is applied to a first pixel so that only red light is recorded for the first pixel, a green filter is applied to a second pixel so that only green light is recorded for the second pixel, and a blue filter is applied to a third pixel so that only blue light is recorded for the third pixel. As a result, the raw sensor data form a mosaic pattern (e.g., a Bayer pattern or a quad-Bayer pattern). The captured image data may need to undergo a demosaicing process in order for each pixel to have proper RGB information.

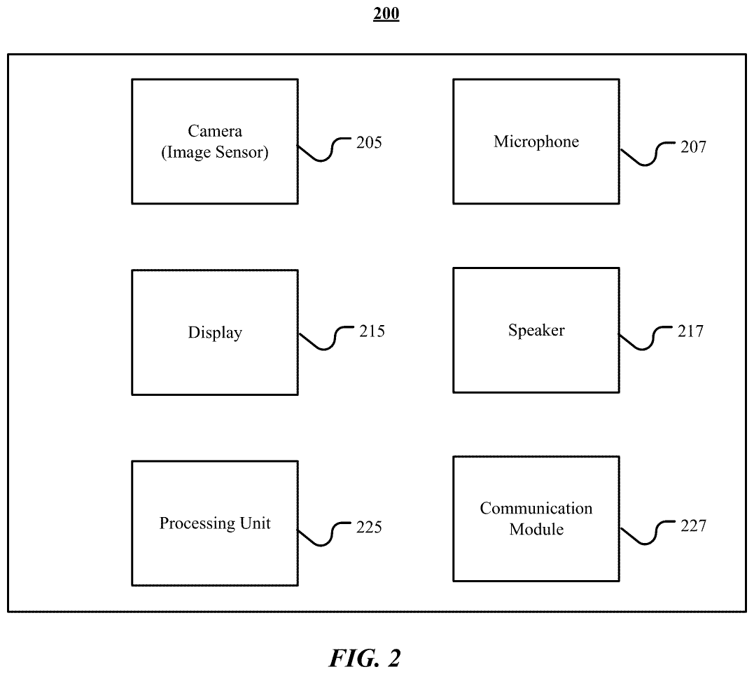

FIG. 2 illustrates an example logical architecture 200 of an HMD 104 or 110. One or more external-facing cameras 205 may comprise one or more image sensors. The external-facing cameras 205 may capture the environment of the user. A microphone 207 may capture audio input from the user or from the environment. The captured image-sensor data or audio data may be processed by the processing unit 225 before being sent to the host computing device 108 through the communication module 227. The host computing device 108 may create artificial reality content. The artificial reality content may include completely generated content or generated content combined with captured visual and/or audio data. The artificial reality content may be transferred from the host computing device 108 to the HMD 104 or 110 through the communication module 227. The artificial reality content may be processed by the processing unit 225 before being presented to the user via a display 215 and/or a speaker 217. Although this disclosure describes a particular logical architecture of an HMD, this disclosure contemplates any suitable architecture of an HMD.

In particular embodiments, a computing system may be associated with an image sensor. The computing system may access image-sensor data generated by the image sensor. The computing system may be an HMD 104 or 110. As an example and not by way of limitation, the HMD 104 may be associated with one or more external-facing cameras 205 that comprise one or more image sensors. When the one or more external-facing cameras 205 capture the environment of the user, the HMD 104 may access raw image-sensor data generated by the one or more image sensors. The raw image-sensor data may be transferred from the one or more image sensors of the one or more cameras 205 to the processing unit 225 through a bus, or through any suitable data transmission medium. Although this disclosure describes accessing image-sensor data in a particular manner, this disclosure contemplates accessing image-sensor data in any suitable manner.

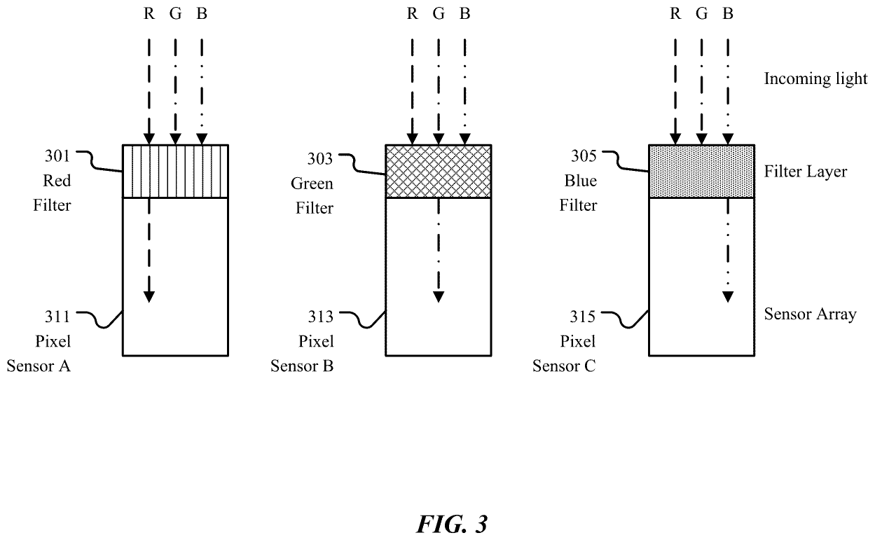

The image sensor may convert light information for the image into electrical data for each pixel. The image sensor may have a color filter array with a pre-determined number of filter sets. Each filter set may have a single color. A filter of the color filter array may pass light information for a corresponding color. Each pixel in the image sensor may be associated with a filter. FIG. 3 illustrates an example image sensor associated with a color filter array. As an example and not by way of limitation, illustrated in FIG. 3, the image sensor comprises a plurality of pixel sensors. FIG. 3 illustrates only three pixel sensors 311, 313, and 315 for a sake of brevity. The image sensor is associated with a color filter array comprising with a pre-determined number of filter sets. Each filter set have a single color. Each filter belongs to one of the filter sets and passes light information for only corresponding color. Each filter is associated with a pixel sensor in the image sensor. In the example illustrated in FIG. 3, a red filter 301 is associated with pixel sensor A 311. As the red filter 301 passes light information only for red, captured data at pixel sensor A 311 may be associated with only red light. The green filter 303 is associated with pixel sensor B 313. As the green filter 303 passes light information only for green, captured data at pixel sensor B 313 may be associated with only green light. The blue filter 305 is associated with pixel sensor C 315. As the blue filter 305 passes light information only for blue, captured data at pixel sensor C 315 may be associated with only blue light. may capture Although this disclosure describes a particular image sensor associated with a color filter array, this disclosure contemplates any suitable image sensor associated with a color filter array.

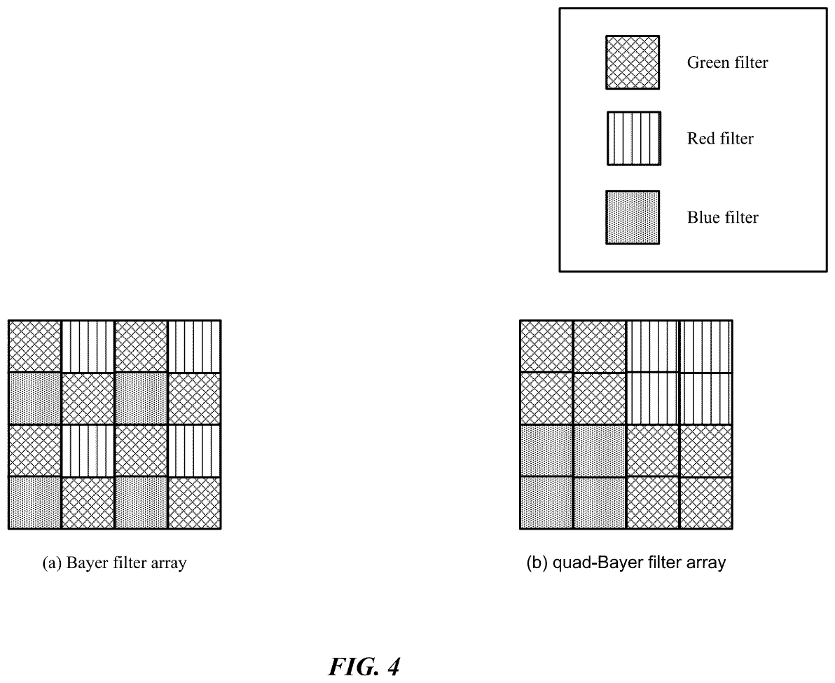

In particular embodiments, a color filter array may comprise a pre-determined number of filter sets. In particular embodiments, the color filter array may be a Bayer filter array, which comprises four filter sets. In particular embodiments, the color filter array may be a quad-Bayer filter array, which comprises sixteen filter sets. FIG. 4 illustrates a comparison between a Bayer filter array pattern and a quad-Bayer filter array pattern. A Bayer filer array pattern may be a repeating 2×2 arrangement as shown in (a). A quad-Bayer filter array pattern may be a repeating 4×4 arrangement as shown in (b). In both color filter arrays, a quarter of the total number of filters are red filters. Another quarter of the total number of filters are blue filters. A half of the total number of filters are green filters.

The Bayer filter array may be suitable for sharp high-resolution images in bright conditions. The quad-Bayer filter array may be suitable to be used in an environment of low illuminance. With a quad-Bayer filer array, adjacent four pixels may be clustered to create per-unit image signal that is four times greater than that of a single pixel. By adding of adjacent pixels in analog, loss of resolution may be prevented, enabling to reduce noise in the resulting image. An ideal computing system may utilize image sensors with Bayer filter array to capture images or videos in an environment of high illuminance and utilize image sensors with quad-Bayer filter array to capture images or videos in an environment of low illuminance. However, certain computing systems, such as an HMD 104 or 110, may not have enough space and/or computing power to be equipped with both Bayer filter array and quad-Bayer filter array. A computing system may have one or more image sensors with quad-Bayer filter arrays. The computing system may perform the demosaicing in a manner that achieves sharp and high-resolution images when the image is taken in an environment of high illuminance. In some legacy systems, the image sensor, in high-illuminance environments, may revert the pixels to the Bayer structure by performing a remosaicing to achieve the high resolution of the Bayer sensor array. The computing system disclosed herein may utilize a machine-learning model to achieve images with minimal noise and maximal resolution either in low-illuminance environments or in high-illuminance environment.

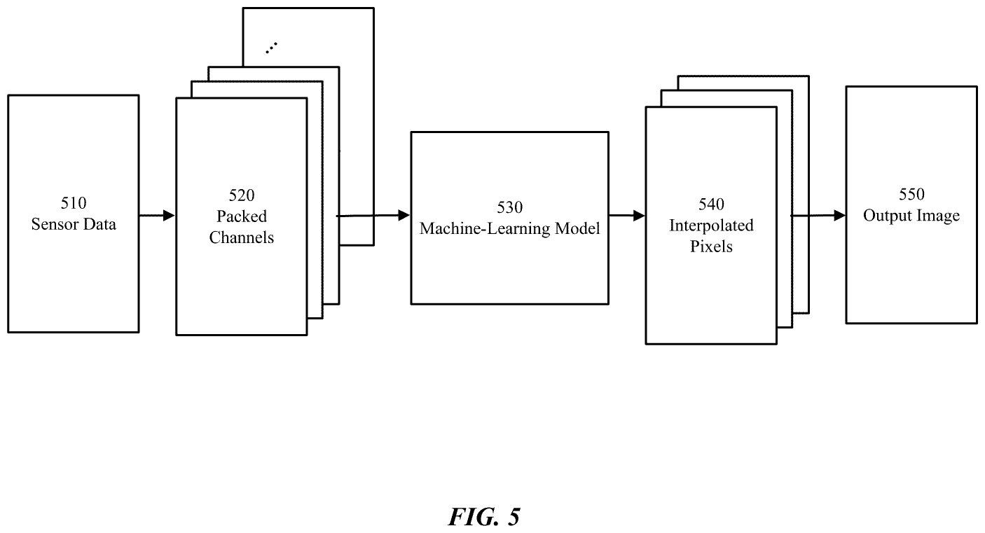

FIG. 5 illustrates an example process of demosaicing quad-Bayer-filtered image-sensor data using a machine-learning model. A computing system may access image-sensor data 510 generated by an image sensor comprising a quad-Bayer color filter array. The computing system may split the image-sensor data 510 into sixteen packed channels 520. The computing system may produce three channels of interpolated pixels 540 by processing the sixteen packed channels 520 using a machine-learning model 530. The computing system may construct an output image 550 using the three channels of the interpolated pixels 540. Although this disclosure describes demosaicing quad-Bayer-filtered image-sensor data using a machine-learning model in a particular manner, this disclosure contemplates demosaicing quad-Bayer-filtered image-sensor data using a machine-learning model in any suitable manner.

In particular embodiments, a computing system associated with an image sensor comprising a quad-Bayer color filter array may access image-sensor data 510 generated by the image sensor. The quad-Bayer color filter array may comprise sixteen sets of filters. Each set of filters may correspond to a pixel location within a quad-Bayer pattern. The computing system may be associated with an artificial-reality (AR) display. As an example and not by way of limitation, the HMD 104 or 110 may be associated with one or more external-facing cameras 205 that comprise one or more image sensors. The one or more image sensors may comprise a quad-Bayer color filter array. When the one or more external-facing cameras 205 capture the environment of the user, the HMD 104 or 110 may access raw image-sensor data 510 generated by the one or more image sensors. The raw image-sensor data 510 may be transferred from the one or more image sensors of the one or more cameras 205 to the processing unit 225 through a bus, or through any suitable data transmission medium. Although this disclosure describes accessing image-sensor data in a particular manner, this disclosure contemplates accessing image-sensor data in any suitable manner.

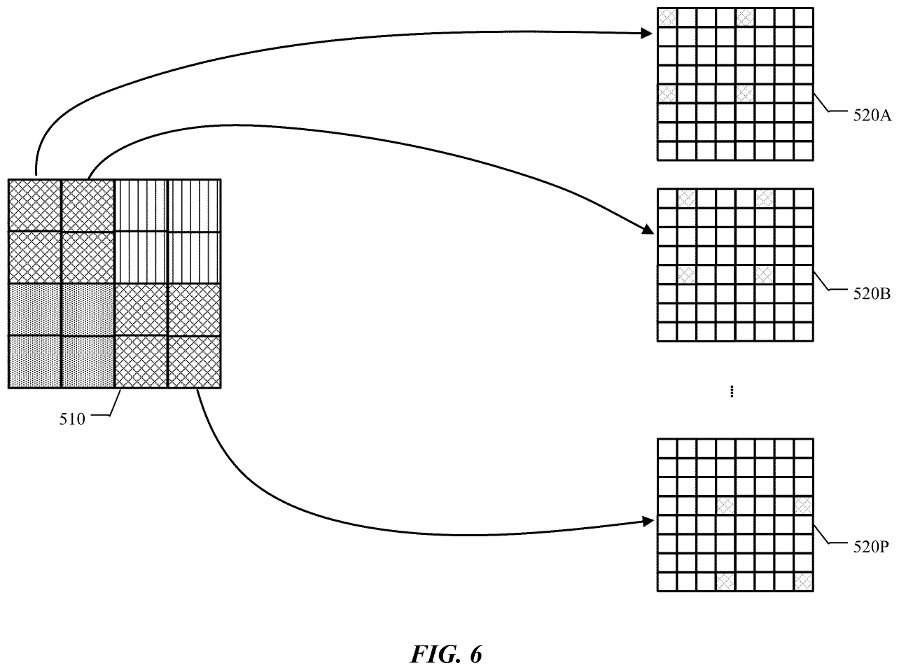

In particular embodiments, the computing system may split the image-sensor data 510 into sixteen packed channels 520. Each of the sixteen packed channels may correspond to one of the sixteen sets of filters. FIG. 6 illustrates an example split of a quad-Bayer-filtered image-sensor data into sixteen packed channels. As an example and not by way of limitation, illustrated in FIG. 6, pixel information for pixels of coordinates (0, 0) of each quad-Bayer pattern in the image-sensor data 510 is represented by a first channel 520A among the sixteen packed channels 520. Pixel information for pixels of coordinates (0, 1) of each quad-Bayer pattern in the image-sensor data 510 is represented by a second channel 520B among the sixteen packed channels 520. Likewise, pixel information for pixels of coordinates (3, 3) of each quad-Bayer pattern in the image-sensor data 510 is represented by a sixteenth channel 520P among the sixteen packed channels 520. Although this disclosure describes splitting an image-sensor data into sixteen packed channels in a particular manner, this disclosure contemplates splitting an image-sensor data into sixteen packed channels in any suitable manner.

In particular embodiments, the computing system may produce three channels of interpolated pixels 540 by processing the sixteen packed channels 520 using a machine-learning model 530. In particular embodiments, the machine-learning model may comprise a series of neural networks (NNs). In particular embodiments, the machine-learning model may comprise a series of convolutional neural networks (CNNs). The three channels may comprise red, green, and blue channels. Each channel may comprise interpolated complete pixel information. Although this disclosure describes producing RGB channels with interpolated pixel information by processing the sixteen packed channels with a machine-learning model in a particular manner, this disclosure contemplates producing RGB channels with interpolated pixel information by processing the sixteen packed channels with a machine-learning model in any suitable manner.

In particular embodiments, the computing system may construct an output image 550 based on the three channels of the interpolated pixels 540. In particular embodiments, the computing system may send the output image 550 to the host computing device 108 through the communication module 227. In particular embodiments, the computing system may present the output image 550 through the display 215 associated with the computing system. Although this disclosure describes constructing an output image based on the RGB channels with interpolated pixel information in a particular manner, this disclosure contemplates constructing an output image based on the RGB channels with interpolated pixel information in any suitable manner.

In particular embodiments, the machine-learning model 530 may be trained with training images selected from a corpus of images. The corpus of images may comprise randomly cropped images. Each image in the corpus of images may be associated with a score determined based on characteristics of the image. The characteristics may comprise spectral signal frequencies associated with the image. A first image with a first score may have a higher probability of being selected for the training than a second training image with a second score that is lower than the first score. As an example and not by way of limitation, a number of digital images may be collected. A corpus of images may be constructed by randomly cropping each of the number of digital images in a pre-determined size. A score may be assigned to each cropped image in the corpus of images based on characteristics of the cropped image. If the cropped image contains much information, a higher score is assigned to the cropped image. If the cropped image contains little information, a lower score is assigned to the cropped image. The amount of information may be determined based on a number of edges in the cropped image, which is represented by frequencies. When training images are selected from the corpus of the images, images with higher scores may have better chance to be selected than images with lower scores. Although this disclosure describes selecting training images from a corpus of images in a particular manner, this disclosure contemplates selecting training images from a corpus of images in any suitable manner.

In particular embodiments, the machine-learning model 530 may be trained through numerous iterations. Each training iteration with a training image may comprise a number of steps. At a first step, image-sensor data may be recovered from the training image. At a second step, the recovered image-sensor data may be split into sixteen packed channels. At a third step, three channels of interpolated pixels may be produced by processing the sixteen packed channels using the machine-learning model. At a fourth step, parameters of the machine-learning model may be updated based on a comparison between the training image and a constructed image using the produced three channels of the interpolated pixels. Although this disclosure describes training a machine-learning model that performs demosaicing quad-Bayer-filtered image-sensor data in a particular manner, this disclosure contemplates training a machine-learning model that performs demosaicing quad-Bayer-filtered image-sensor data in any suitable manner.

In particular embodiments, the training images may be pre-processed by amplifying red and blue pixels. In the recovered image-sensor data, green channels may tend to be brighter. To mitigate this issue, the training images may be pre-processed by amplifying the red and blue pixels. The pre-processing may significantly reduce potential artifacts. Although this disclosure describes pre-processing the training images in a particular manner, this disclosure contemplates pre-processing the training images in any suitable manner.

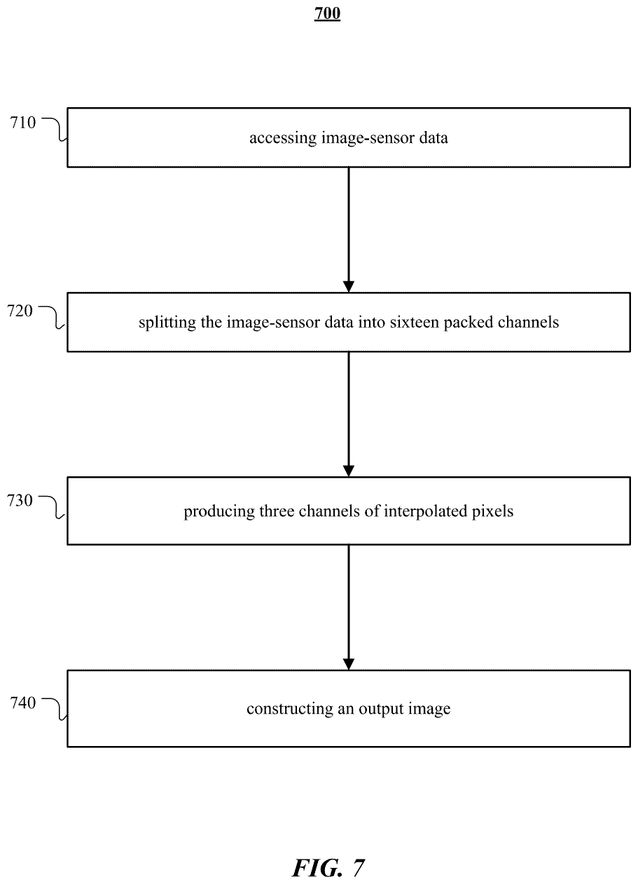

FIG. 7 illustrates an example method 700 for demosaicing quad-Bayer-filtered image-sensor data using a machine-learning model. The method may begin at step 710, where a computing system may access image-sensor data generated by the image sensor. The quad-Bayer color filter array may comprise sixteen sets of filters. Each set of filters may correspond to a pixel location within a quad-Bayer pattern. At step 720, the computing system may split the image-sensor data into sixteen packed channels. Each of the sixteen packed channels may correspond to one of the sixteen sets of filters. At step 730, the computing system may produce three channels of interpolated pixels by processing the sixteen packed channels using a machine-learning model. The three channels may comprise red, green, and blue channels. At step 740, the computing system may construct an output image using the three channels of the interpolated pixels. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for demosaicing quad-Bayer-filtered image-sensor data using a machine-learning model including the particular steps of the method of FIG. 7, this disclosure contemplates any suitable method for demosaicing quad-Bayer-filtered image-sensor data using a machine-learning model including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

### Systems and Methods

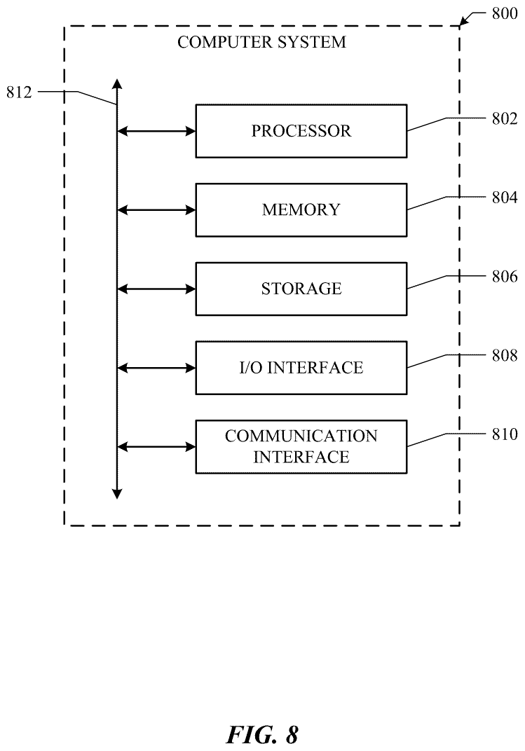

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system associated with an image sensor comprising a quad-Bayer color filter array:
accessing image-sensor data generated by the image sensor, wherein the quad-Bayer color filter array comprises sixteen sets of filters, each corresponding to a pixel location within a quad-Bayer pattern;
splitting the image-sensor data into sixteen packed channels, wherein each of the sixteen packed channels corresponds to one of the sixteen sets of filters;
producing three channels of interpolated pixels by processing the sixteen packed channels using a machine-learning model, wherein the three channels comprise red, green, and blue channels; and
constructing an output image using the three channels of the interpolated pixels.

2. The method of claim 1, wherein the machine-learning model comprises a series of neural networks (NNs).

3. The method of claim 1, wherein the machine-learning model comprises a series of convolutional neural networks (CNNs).

4. The method of claim 1, wherein the computing system is associated with an artificial-reality (AR) display.

5. The method of claim 1, wherein the machine-learning model is trained with training images selected from a corpus of images.

6. The method of claim 5, wherein the corpus of images comprise randomly cropped images, and wherein each image in the corpus of images is associated with a score determined based on characteristics of the image.

7. The method of claim 6, wherein a first image with a first score has a higher probability of being selected for the training than a second training image with a second score that is lower than the first score.

8. The method of claim 6, wherein the characteristics comprise spectral signal frequencies associated with the image.

9. The method of claim 5, wherein training the machine-learning model with a training image comprises:
recovering image-sensor data from the training image;
splitting the recovered image-sensor data into sixteen packed channels;
producing three channels of interpolated pixels by processing the sixteen packed channels using the machine-learning model; and
updating parameters of the machine-learning model based on a comparison between the training image and a constructed image using the produced three channels of the interpolated pixels.

10. The method of claim 5, wherein the training images are pre-processed by amplifying red and blue pixels.

11. One or more computer-readable non-transitory storage media embodying software that is operable on a computing system associated with an image sensor comprising a quad-Bayer color filter array when executed to:
access image-sensor data generated by the image sensor, wherein the quad-Bayer color filter array comprises sixteen sets of filters, each corresponding to a pixel location within a quad-Bayer pattern;
split the image-sensor data into sixteen packed channels, wherein each of the sixteen packed channels corresponds to one of the sixteen sets of filters;
produce three channels of interpolated pixels by processing the sixteen packed channels using a machine-learning model, wherein the three channels comprise red, green, and blue channels; and
construct an output using the three channels of the interpolated pixels.

12. The media of claim 11, wherein the machine-learning model comprises a series of convolutional neural networks (CNNs).

13. The media of claim 11, wherein the computing system is associated with an artificial-reality (AR) display.

14. The media of claim 11, wherein the machine-learning model is trained with training images selected from a corpus of images.

15. The media of claim 14, wherein the corpus of images comprise randomly cropped images, and wherein each image in the corpus of images is associated with a score determined based on characteristics of the image.

16. The media of claim 15, wherein a first image with a first score has a higher probability of being selected for the training than a second training image with a second score that is lower than the first score.

17. The media of claim 15, wherein the characteristics comprise spectral signal frequencies associated with the image.

18. The media of claim 14, wherein training the machine-learning model with a training image comprises:
recovering image-sensor data from the training image;
splitting the recovered image-sensor data into sixteen packed channels;
producing three channels of interpolated pixels by processing the sixteen packed channels using the machine-learning model; and
updating parameters of the machine-learning model based on a comparison between the training image and a constructed image using the produced three channels of the interpolated pixels.

19. A computing system comprising:
one or more processors;
an image sensor comprising a quad-Bayer color filter array; and
one or more computer-readable non-transitory storage media coupled to one or more of the processors and comprising instructions operable when executed by one or more of the processors to cause the system to:
access image-sensor data generated by the image sensor, wherein the quad-Bayer color filter array comprises sixteen sets of filters, each corresponding to a pixel location within a quad-Bayer pattern;
split the image-sensor data into sixteen packed channels, wherein each of the sixteen packed channels corresponds to one of the sixteen sets of filters;
produce three channels of interpolated pixels by processing the sixteen packed channels using a machine-learning model, wherein the three channels comprise red, green, and blue channels; and
construct an output using the three channels of the interpolated pixels.

20. The computing system of claim 19, wherein the machine-learning model comprises a series of convolutional neural networks (CNNs).
